(19) United States
(12) Patent Application Publication
(10) Pub. No.: US 2011/0178829 A1
(43) Pub. Date: Jul. 21, 2011

(54) METHOD AND SYSTEM FOR GENERATING AN INCLUSIVITY INDEX OF AN ORGANIZATION

(75) Inventors: Geetha Kannan, Bangalore (IN); Srimathi Shivashankar, Chennai (IN); Dipankar Khasnabish, Bangalore (IN)

(73) Assignee: INFOSYS TECHNOLOGIES LIMITED, Bangalore (IN)

(21) Appl. No.: 12/689,018

(22) Filed: Jan. 18, 2010

(51) Int. Cl. G06Q 10/00

(52) U.S. Cl. 705/7.11

(57) ABSTRACT

The present invention provides a method, system and computer program product for generating an inclusivity index of an organization. The inclusivity index is generated for various groups of individuals employed by the organization. Various parameters associated with the organization are identified. Further, a relative weight is generated for the parameters. Thereafter, a primary feedback is received for various parameters by individuals associated with a group. Subsequently, a secondary feedback is generated for each parameter. The inclusivity index is then calculated on the basis of the secondary feedback and the relative weight.

### BACKGROUND OF THE INVENTION

The present invention relates to generating an inclusivity index of an organization. More specifically, it relates to generating an inclusivity index for various groups of individuals in an organization.

Today, various organizations hire individuals from across the globe. Employees of these organizations have different educational, social, and cultural backgrounds. Therefore, it is important for an organization to provide a common platform to its employees to make them feel comfortable and increase the inclusion level in spite of the diversity. Further, the organization needs to fulfill the needs of its employees and simultaneously create a work environment that fosters the growth of the organization as well as of its employees.

In order to create a work environment that increases the inclusion level of employees, organizations implement various policies. Further, the organizations generally conduct surveys prior to implementing any policy to understand the employees' outlook toward the organization. These surveys help the organization to understand the inclusion level of the employees with the organization. The surveys also include various parameters/questions on which the employees are asked to respond. Although these surveys are conducted to understand the inclusion level of the employees, there are various disadvantages associated with these surveys.

Firstly, the parameters need to be modified on the basis of the survey to be conducted. For example, a set of parameters may be different for working mothers and a group of people above a predefined age. Further, the parameters that are identified are not comprehensive to encompass the employees' needs and the organization's business requirements. In other words, the identified parameters also fail to synchronize the needs of the employees and the business requirements of the organization. In addition to the failure in selecting a good set of parameters, the organizations also fail to understand the importance of a parameter over the other parameters.

Secondly, the feedback received on the parameters from various employees is analyzed by the senior management of the organization. The senior management fails to understand the importance associated with the parameters and therefore provide a judgment based on their experience which is generally subjective in nature. Thus, such analysis of the feedback is not comprehensive and the organizations do not get a complete picture of the inclusion level of the employees. Therefore, the organizations in pursuit of increasing the inclusion level of the employees implement wrong measures and policies.

In light of the discussion above, there is a need for a method, system and computer program product for generating an inclusivity index of an organization. Further, the inclusivity index should be an objective value that enables the organization to measure the inclusion level of the employees in an efficient manner. Furthermore, the parameters selected for the survey need to be generic and the feedback associated with the parameters needs to be evaluated in a comprehensive manner.

### BRIEF SUMMARY OF THE INVENTION

An object of the invention is to measure an inclusion level of at least one group of individuals of an organization.

Another object of the invention is to measure the quality of the work environment provided by an organization.

Yet another object of the invention is to enable an organization to adapt to various strategies and initiatives on the basis of an inclusion level generated for at least one group of individuals.

To achieve the objectives mentioned above, the invention provides a method, system and computer program product for generating an inclusivity index of an organization. Further, the inclusivity index is generated for at least one group of individuals employed by the organization. A plurality of parameters associated with the organization is identified by one or more experts and a relative weight is generated for each identified parameter.

Thereafter, a survey is conducted for the at least one group. The survey includes various parameters for which the individuals associated with the group provide primary feedback for each parameter. Subsequently, the primary feedback provided for each parameter by various individuals is collated to generate a secondary feedback corresponding to each parameter. An inclusivity index is then calculated on the basis of the secondary feedback and the relative weight associated with each parameter.

The method, system and computer program product described above have a number of advantages. The method generates an inclusivity index of an organization at a group level. This enables the organization to measure the inclusion level of various individuals associated with the group. This also enables the organization to understand the level of emotional attachment that its employees have for the organization. Further, the inclusivity index facilitates the organization to understand the needs of its employees in an efficient manner. This facilitates the organization to plan its strategies and policies according to the needs of the employees. For example, if an organization targets a group of working mothers to understand their inclusion level, then, based on the inclusivity index generated, it can efficiently understand their needs, and may decide to decrease the working hours for them.

The parameters identified to generate the inclusivity index encompass various needs of the employees and also the business requirements of the organization. The inclusivity index generated on the basis of these parameters enables the organization to get an overall picture about its emotional engagement with the various groups in the organization. With the help of the inclusivity index, the organization can set specific goals and can modify its policies accordingly to attain better retention and satisfaction levels of its employees. This helps the organization to develop better business and working standards across the globe.

### BRIEF DESCRIPTION OF THE DRAWINGS

The various embodiments of the invention will hereinafter be described in conjunction with the appended drawings, provided to illustrate and not to limit the invention, wherein like designations denote like elements, and in which:

FIG. 1 is a flowchart of a method for generating an inclusivity index of an organization; and

FIG. 2 is a block diagram of a system for generating an inclusivity index of an organization.

### DETAILED DESCRIPTION

The invention describes a method, system and computer program product for generating an inclusivity index of an organization. The inclusivity index is generated for various groups of individuals employed by the organization. The inclusivity index is a measure of an inclusion level of the individuals with the organization. Further, the inclusivity index is a measure of the level of inclusive work environment provided by the organization. In various embodiments of the invention, the inclusivity index is generated on the basis of a survey conducted for at least one group of individuals in the organization.

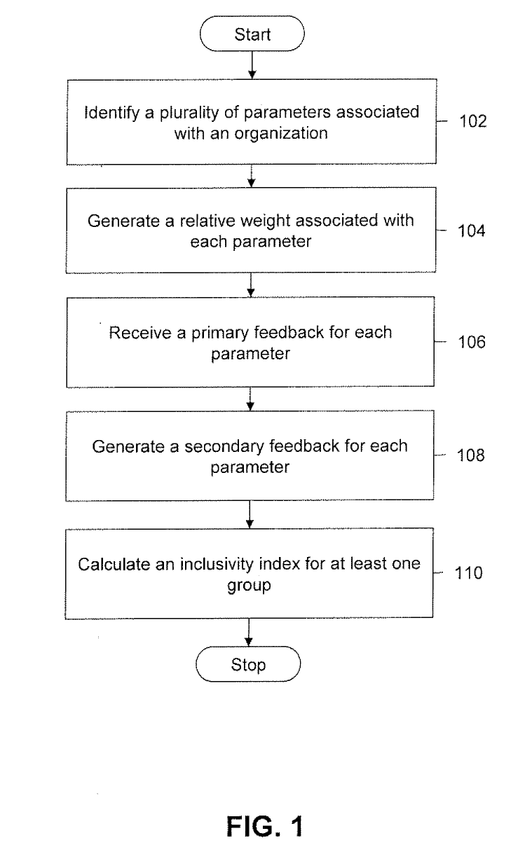

FIG. 1 is a flowchart of a method for generating an inclusivity index of an organization.

In various embodiments of the invention, an inclusivity index is generated for at least one group of an organization. The inclusivity index for the group defines an inclusion level which relates to the emotional attachment of the group with the organization. Furthermore, the inclusivity index of the organization is an objective measure or, in other words, mathematical measure of providing the organization's inclusivity with the group. The method, as described below, generates the inclusivity index of the organization by generating the inclusivity index for the group of individuals employed by the organization.

At 102, a plurality of parameters associated with the organization is identified. The parameters are identified considering an average employees' outlook, expectations from the work and organization, business requirements of the organization, and the like. Further, the identified parameters are generic and, therefore, are applicable to almost all industries. Examples of the industries include, but are not limited to, Information Technology (IT) outsourcing industry, manufacturing industry, consulting industry, banking industry, and the like.

In an exemplary embodiment of the invention, the identified parameters are in the form of questions. These questions are identified to understand the employees and their outlook toward the organization. For example, for an organization such as Infosys, the parameters may be, i. Do you think Infosys is an inclusive company?, ii. Were you provided with a support system to help you to understand the ‘Infosys ways of doing things’ during your first month in the company?, iii. Do you understand Infosys' values and culture?, iv. Does the work environment endorse Infosys' values?, v. Are Infosys' policies aligned to the diverse needs of the individuals?, and the like. In another embodiment of the invention, the parameters can be grouped under one or more categories. For example, the categories can be people, work environment and policies, and so forth, under which the parameters mentioned above can be grouped.

In an embodiment of the invention, the plurality of parameters is identified by one or more experts. These experts are the people who have spent a considerable amount of time with the organization and belong to the senior management of the organization. These experts have wide knowledge about the organization's culture and strategies, and have a better understanding of its diversity and business.

At 104, a relative weight is generated for the corresponding identified parameters. The relative weight for each parameter is generated by using a structured technique. In an embodiment of the invention, the structured technique used is Analytic Hierarchy Process (AHP). In an embodiment of the invention, the relative weight may be a numerical value. For example, the parameters may have relative weights as 20%, 5%, 15%, and the like.

The relative weight associated with a parameter is generated on the basis of the relative importance assigned to each parameter when compared with the other parameters. In an embodiment of the invention, the relative importance is assigned on the basis of the importance associated with the parameter in the organization. For example, the third parameter, Do you understand Infosys' values and culture?, may be more important when compared with the first parameter, Do you think Infosys is an inclusive company?. However, the fifth parameter, Are Infosys' policies aligned to the diverse needs of the individuals?, may be equally important when compared with the first parameter. In an embodiment of the invention, the relative importance is a numeric value assigned on the basis of a predefined scale. Therefore, the third parameter may be assigned ‘5’, and the fifth and first parameters may be assigned ‘1’ as the corresponding relative importance, when both the parameters are compared with the first parameter. In an exemplary embodiment, ‘1’ may be assigned when both the parameters are equally important and ‘5’ may be assigned when the parameter that is being compared is of higher importance. Similarly, a relative importance is assigned to each parameter when compared with the rest of the parameters. Thereafter, a cumulative weight is calculated for each parameter on the basis of the assigned relative importance. Subsequently, the cumulative weight assigned to each parameter is normalized to generate the relative weight corresponding to each parameter. In another embodiment of the invention, the relative importance can be provided in the form of characters and alphanumeric values.

It may be apparent to any person skilled in the art that when the parameters are categorized into various categories, the relative importance is first assigned to the categories and then to the parameters associated with the categories, to generate relative weights corresponding to the categories and the associated parameters.

The relative importance is assigned by one or more experts. As discussed above, the experts are the people who are well aware of the behavior and business requirements of the organization. Therefore, they are the best people to decide the relative importance of the parameters.

At 106, a primary feedback is received for each identified parameter from a plurality of individuals associated with a group. In an embodiment of the invention, the group to be targeted is initially decided by the organization and thereafter, a survey is conducted for the targeted group. Various examples of the group that can participate in the survey can be a business unit of the organization, people from a particular geography, a group of working mothers, a group of engineers, a group of recruits, a group of people above or below a specific age, and the like. Further, the individuals in these groups can have diverse social, educations, and cultural backgrounds. In an embodiment of the invention, a hypothesis to be checked is selected and a group is accordingly targeted by the organization for the survey. For example, ‘Are working mothers happier than unmarried women?’

In various embodiments of the invention, the survey is conducted for the targeted group by circulating the identified parameters in the form of a questionnaire. Various examples of conducting the survey may include, but are not limited to, a paper questionnaire, an online questionnaire, a telephonic questionnaire, and the like.

The primary feedback for each parameter is received on the basis of a predefined scale. In an embodiment of the invention, the primary feedback can be a numeric value defined on a predefined scale. For example, the individuals provide rating as 1, 2, 3, 4, or 5 on a scale of 1 to 5. Further, each numeric value may correspond to comments, such as 1 being unsatisfactory, 2 being average, and so on. In another embodiment of the invention, the primary feedback can be in the form of one or more characters, for example, a, b, c d, and e, on a scale of a to e. In yet another embodiment of the invention, the primary feedback can be alphanumeric values, for example, α, β, γ, δ and ε, on a scale of α to ε.

At 108, a secondary feedback is generated for each parameter. The secondary feedback associated with the parameter is generated by collating the primary feedback provided by various individuals of the targeted group corresponding to the parameter. In an embodiment of the invention, the secondary feedback is generated by calculating an average of the primary feedback provided by the various individuals corresponding to the parameter. For example, if for parameter 1, a group consisting of five individuals provided the primary feedback as 2, 3, 3, 3, 4, then, the secondary feedback generated is 3 ((2+3+3+3+4)/5).

At 110, an inclusivity index for the group is calculated on the basis of the secondary feedback and the corresponding relative weight for each parameter. In an embodiment of the invention, a weighted average of the relative weight and the corresponding secondary feedback associated with various parameters is calculated. For example, if the survey has 5 parameters with relative weights as 20%, 30%, 5%, 20% and 25% and their corresponding secondary feedback was 2, 3, 3, 2, and 4, respectively, then, the inclusivity index calculated for the group is 2.85 (2*0.2+3*0.3+3*0.05+2*0.02+4*0.25). It may be apparent to a person skilled in the art that the inclusivity index generated will be on the same predefined scale used to collect the primary feedback.

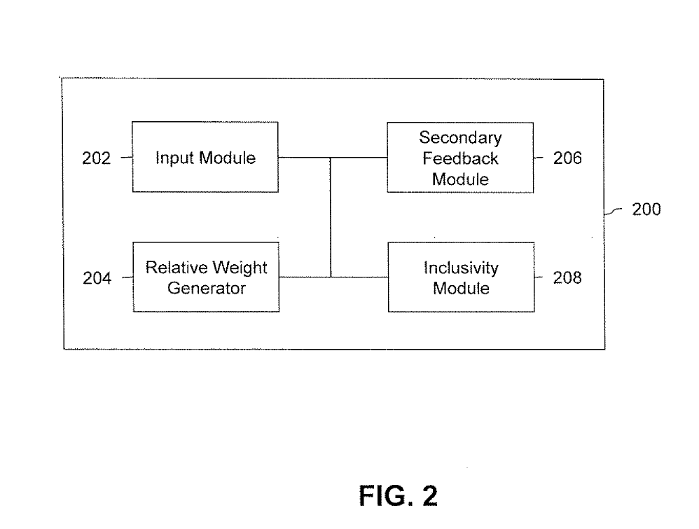

FIG. 2 is a block diagram of a system 200 for generating an inclusivity index of an organization. System 200 includes an input module 202, a relative weight generator 204, a secondary feedback module 206, and an inclusivity module 208.

In various embodiments of the invention, system 200 generates an inclusivity index for at least one group of individuals employed by an organization. As explained above, the inclusivity index for the group defines an inclusion level, which relates to the emotional attachment of the individuals associated with the group. Further, the inclusivity index is an objective measure of the organization's inclusivity with its employees. The generation of the inclusivity index by system 200 is explained below in detail.

Input module 202 receives a plurality of parameters associated with the organization. As explained above, these parameters are identified by one or more experts and are provided as a questionnaire to various individuals associated with the group participating in the survey. Various details about the parameters have been explained in detail in conjunction with FIG. 1.

Input module 202 receives a primary feedback corresponding to each parameter from a plurality of individuals associated with the group. In an embodiment of the invention, the primary feedback may be a numeric value. In another embodiment of the invention, the primary feedback may be one or more characters. In yet another embodiment of the invention, the primary feedback may an alphanumeric value.

In various embodiments of the invention, input module 202 can be implemented in the form of a Graphical User Interface (GUI). For example, a user may feed the primary feedback corresponding to each parameter provided by various individuals associated with the group through input module 202.

Input module 202 receives a relative importance corresponding to the various parameters from the user. In an embodiment of the invention, the relative importance is a numeric value assigned by one or more experts. The relative importance has been explained in detail in conjunction with FIG. 1.

Relative weight generator 204 generates a relative weight corresponding to each parameter. In various embodiments of the invention, the relative weight is a numeric value, for example, 20%, 15%, and the like. Further, the relative weight is generated on the basis of the relative importance assigned to each parameter. It may be apparent to a person skilled in the art that, relative weight generator 204 generates the relative weight by using a structured technique. In an embodiment of the invention, the structured technique may be Analytic Hierarchy Process (AHP).

Secondary feedback module 206 generates a secondary feedback corresponding to each parameter by collating the primary feedback received by the various individuals for the parameter. In an embodiment of the invention, secondary feedback module 206 calculates an average of the primary feedback provided by the various individuals corresponding to the parameter. For example, if for parameter 1, a group consisting of five individuals provided the primary feedback as 2, 3, 3, 3, and 4, the collated secondary feedback generated by secondary feedback module 206 is 3 ((2+3+3+3+4)/5). Similarly, secondary feedback module 206 generates secondary feedback corresponding to each parameter.

Inclusivity module 208 calculates an inclusivity index for the group on the basis of the secondary feedback and the relative weight corresponding to each parameter. In an embodiment of the invention, inclusivity module 208 calculates a weighted average of the relative weight and the corresponding secondary feedback associated with the various parameters. For example, if the survey has 5 parameters having relative weights as 20%, 30%, 5%, 20% and 25%, and their corresponding secondary feedback is 2, 3, 3, 2, and 4, respectively, then, the inclusivity index calculated for the group is 2.85 (2*0.2+3*0.3+3*0.05+2*0.02+4*0.25).

The method, system and computer program product described above have a number of advantages. The method generates an inclusivity index of an organization at a group level. This enables the organization to measure the inclusion level of various individuals associated with the group. This also enables the organization to understand the level of emotional attachment their employees share with the organization. Further, the inclusivity index facilitates the organization to understand the needs of the individuals in an efficient manner. This enables the organization to plan its strategies and policies according to the needs of its employees. For example, if the organization targets a group of working mothers to understand their inclusion level, then, on the basis of the inclusivity index generated, it can efficiently understand their needs and may decide to decrease the working hours for them.

Further, the parameters identified for generating the inclusivity index encompass various needs of the individuals and also the business requirements of the organization. The inclusivity index generated on the basis of these parameters enables the organization to get an overall picture about its emotional attachment with the various groups. With the help of the inclusivity index, the organization can target specific goals and can modify its policies accordingly to attain better retention and satisfaction levels of its employees. This also helps the organization to develop better business and working standards across the globe.

The system for generating an inclusivity index for at least one group of an organization, as described in the present invention or any of its components, may be embodied in the form of a computer system. Typical examples of a computer system include a general-purpose computer, a programmed microprocessor, a micro-controller, a peripheral integrated circuit element, and other devices or arrangements of devices that are capable of implementing the steps that constitute the method of the present invention.

The computer system comprises a computer, an input device, a display unit and the Internet. The computer also comprises a microprocessor, which is connected to a communication bus. The computer also includes a memory, which can be Random Access Memory (RAM) and Read Only Memory (ROM). The computer system also comprises a storage device, which can be a hard disk drive or a removable storage drive such as a floppy disk drive, an optical disk drive, etc. The storage device can also be other similar means for loading computer programs or other instructions into the computer system. The computer system also includes a communication unit, which enables the computer to connect to other databases and the Internet through an I/O interface. The communication unit enables the transfer as well as reception of data from other databases. The communication unit may include a modem, an Ethernet card, or any similar device which enables the computer system to connect to databases and networks such as LAN, MAN, WAN and the Internet. The computer system facilitates inputs from a user through an input device, accessible to the system through the I/O interface.

The computer system executes a set of instructions that are stored in one or more storage elements, in order to process input data. The storage elements may also hold data or other information as desired. The storage element may be in the form of an information source or a physical memory element present in the processing machine.

The set of instructions may include various commands that instruct the processing machine to perform specific tasks such as the steps that constitute the method of the present invention. The set of instructions may be in the form of a software program. Further, the software may be in the form of a collection of separate programs, a program module with a long program or a portion of a program module, as in the present invention. The software may also include modular programming in the form of object-oriented programming. The processing of input data by the processing machine may be in response to user commands, results of previous processing or a request made by another processing machine.

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

1. A method for generating an inclusivity index of an organization, the inclusivity index being generated for one or more groups in an organization, each of the one or more groups comprising a plurality of individuals, the plurality of individuals being employed by the organization, the method comprising:
a. identifying a plurality of parameters associated with the organization, the plurality of parameters being identified by one or more experts;
b. generating a relative weight associated with each of the plurality of parameters, the relative weight being generated using a structured technique;
c. receiving a primary feedback for each of the plurality of parameters, the primary feedback being provided by at least one of the plurality of individuals of at least one group;
d. generating a secondary feedback for each of the plurality of parameters, the secondary feedback being generated by collating the primary feedback provided for each of the plurality of parameters; and
e. calculating the inclusivity index for the at least one group based on the secondary feedback for each of the plurality of parameters and the corresponding relative weight for each of the plurality of parameters.

2. The method according to claim 1 further comprising grouping at least one of the plurality of parameters under one or more categories, the at least one of the plurality of parameters being grouped by one or more experts.

3. The method according to claim 1, wherein the structured technique is an Analytic Hierarchy Process (AHP).

4. The method according to claim 1, wherein the relative weight is generated based on relative importance of the plurality of parameters, the relative importance being decided by one or more experts.

5. The method according to claim 1, wherein the primary feedback is received in form of one or more characters, the one or more characters being received based on a pre-defined scale.

6. The method according to claim 1, wherein the primary feedback is received in form of a numeric value, the numeric value being received based on a pre-defined scale.

7. The method according to claim 1, wherein the primary feedback is received in form of an alphanumeric value, the alphanumeric value being received based on a pre-defined scale.

8. The method according to claim 1, wherein the plurality of parameters are related to policies of the organization.

9. The method according to claim 1, wherein the plurality of parameters are related to the work environment of the organization.

10. The method according to claim 1, wherein the plurality of parameters are related to plurality of individuals of the organization.

11. The method according to claim 1, wherein each of the plurality of individuals are from diverse backgrounds, the diverse backgrounds being at least one of educational background, social background and cultural background.

12. A system for generating an inclusivity index of an organization, the inclusivity index being generated for one or more groups in an organization, each of the one or more groups comprising a plurality of individuals, the plurality of individuals being employed by the organization, the system comprising:
a. an input module configured for
i. receiving a plurality of parameters associated with the organization, the plurality of parameters being provided by one or more experts;
ii. receiving a primary feedback for each of the plurality of parameters, the primary feedback being provided by at least one of the plurality of individuals of at least one group;
b. a relative weight generator configured for generating a relative weight for each of each of the plurality of parameters, the relative weight being generated using a structured technique;
c. a secondary feedback module configured for generating a secondary feedback for each of the plurality of parameters, the secondary feedback being generated by collating the primary feedback provided for each of the plurality of parameters; and
d. an inclusivity module configured for calculating the inclusivity index for the at least one group based on the secondary feedback for each of the plurality of parameters and the corresponding relative weight associated with each of the plurality of parameters.

13. The system according to claim 12, wherein the input module is further configured for receiving a relative importance corresponding to each of the plurality of parameters, the relative importance being decided by one or more experts.

14. The system according to claim 13, wherein the relative weight generator generates the relative weight based on the relative importance corresponding to each of the plurality of parameters.

15. The system according to claim 12, wherein the structured technique is an Analytic Hierarchy Process (AHP).

16. The system according to claim 12, wherein the primary feedback is received in form of one or more characters, the one or more characters being received based on a pre-defined scale.

17. The system according to claim 12, wherein the primary feedback is received in form of a numeric value, the numeric value being received based on a pre-defined scale.

18. The system according to claim 12, wherein the primary feedback is received in form of an alphanumeric value, the alphanumeric value being received based on a pre-defined scale.

19. A computer program product for use with a computer, the computer program product comprising a computer usable medium having a computer readable program code embodied therein for generating an inclusivity index of an organization, the inclusivity index being generated for one or more groups in an organization, each of the one or more groups comprising a plurality of individuals, the plurality of individuals being employed by the organization, the computer readable code performing:
a. generating a relative weight associated with each of a plurality of parameters, the relative weight being generated using a structured technique, wherein the plurality of parameters are associated with the organization, the plurality of parameters being identified by one or more experts;
b. generating a secondary feedback for each of the plurality of parameters, the secondary feedback being generated by collating a primary feedback provided for each of the plurality of parameters, wherein the primary feedback is received for each of the plurality of parameters, the primary feedback being provided by at least one of the plurality of individuals of at least one group; and
c. calculating the inclusivity index for the at least one group based on the secondary feedback for each of the plurality of parameters and the corresponding relative weight for each of the plurality of parameters.

20. The computer program product according to claim 19, wherein the structured technique is an Analytic Hierarchy Process (AHP).

21. The computer program product according to claim 19, wherein the relative weight is generated based on relative importance of the plurality of parameters, the relative importance being decided by one or more experts.

22. The computer program product according to claim 19, wherein the primary feedback is received in form of one or more characters, the one or more characters being received based on a pre-defined scale.

23. The computer program product according to claim 19, wherein the primary feedback is received in form of a numeric value, the numeric value being received based on a pre-defined scale.

24. The computer program product according to claim 19, wherein the primary feedback is received in form of an alphanumeric value, the alphanumeric value being received based on a pre-defined scale.
